(19) United States
(12) Patent Application Publication
(10) Pub. No.: US 2019/0045143 A1
(43) Pub. Date: Feb. 7, 2019

(54) PORTABLE VIDEO PRODUCTION SYSTEM

(71) Applicant: WIZARD OF ADS, SUNPOP STUDIOS LTD., Austin, TX (US)

(72) Inventor: Roy H. Williams, IV, Austin, TX (US)

(21) Appl. No.: 15/665,792

(22) Filed: Aug. 1, 2017

(51) Int. Cl. H04N 5/28; H04N 7/18; G11B 27/032; H04N 5/765

(52) U.S. Cl. CPC H04N 5/28; H04N 5/765; G11B 27/032; H04N 7/181

(57) ABSTRACT

A portable door video production system includes a base, a device holder, and a lighting portion. The base securely mounts on an edge of a door. The device holder to couple with the base, to swivel and move in relation to the base mounted on the door, and to hold a device a desired position to provide a proper angle to film a user. The lighting portion to couple with the device holder. The lighting portion includes a light, and holds the light in a desired lighting position.

### FIELD OF THE DISCLOSURE

This disclosure generally relates to a video capture system, and more particularly relates to a portable video production system.

### BACKGROUND

Companies can create videos for a variety of uses, such as instructional videos, commercials, informative videos, and the like. The company may need to hire a video production company to produce the video for them. To create the video, the person or persons that may be in the video can then go to the production company's location to shoot the video, the production company can send an entire production crew including equipment and personnel to the company's office, or the like.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIGS. 1 and 2 are different views of a portable door video production system in accordance with at least one embodiment of the present disclosure;

FIG. 3 is a front view of a prompter component connected in front of a device of the portable door video production system in accordance with at least one embodiment of the present disclosure; and

FIG. 4 is a front view of the portable door video production system including a microphone portion connected to the device in accordance with at least one embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application.

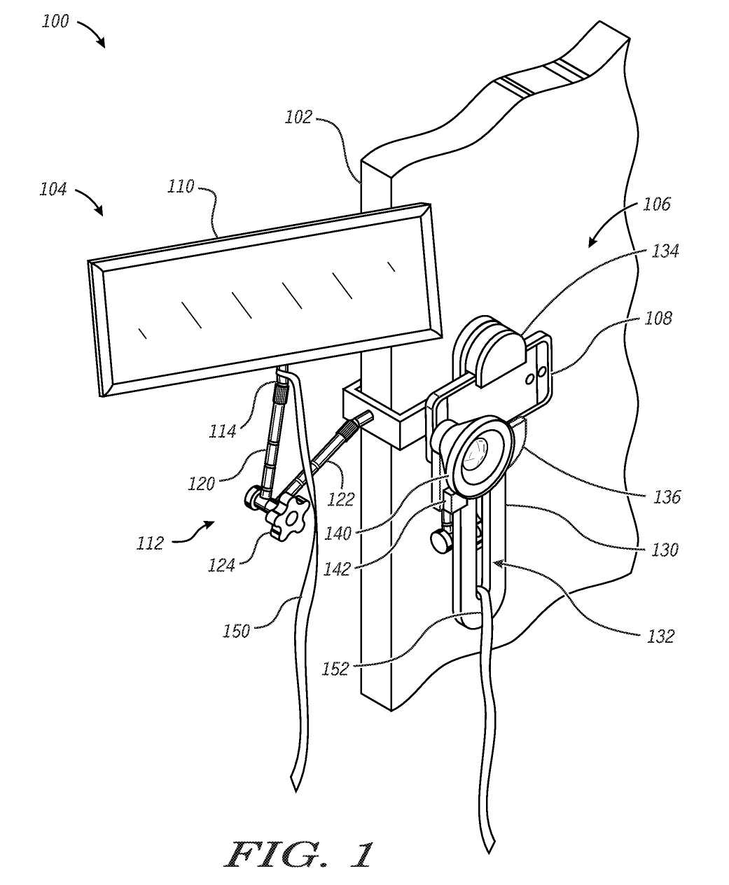

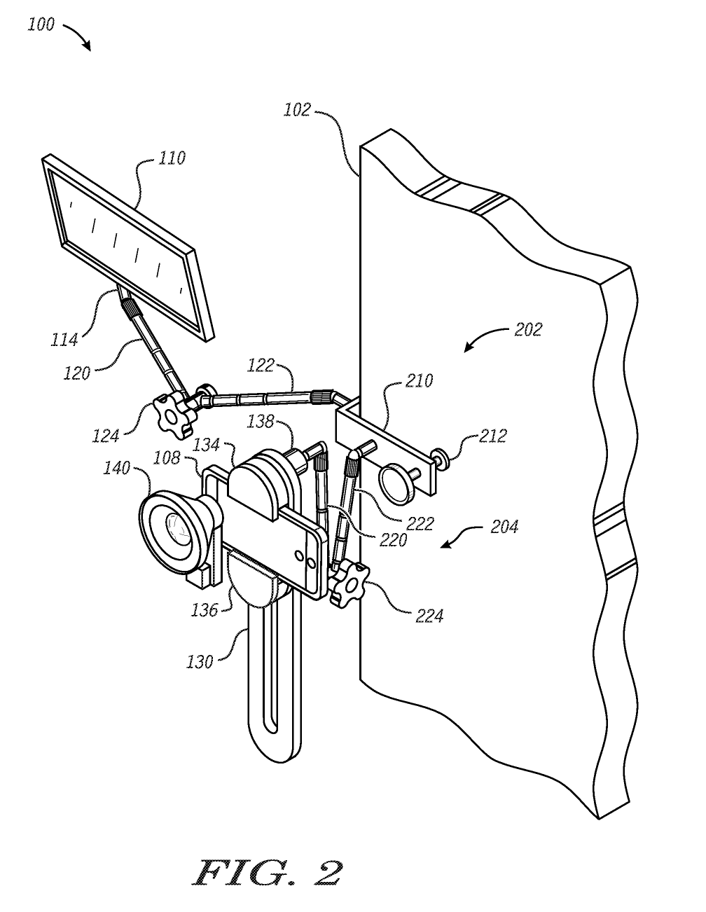

FIGS. 1 and 2 show a portable door video production system 100 capable of being mounted on a door 102 in accordance with at least one embodiment of the present disclosure. The portable video production system 100 includes a lighting portion 104, and a device holder 106, which in turn can securely hold a device 108. In an embodiment, the device 108 can be any device capable of capturing video and audio, such as a telephone equipped with a microphone and with a front facing camera, a tablet device equipped with a microphone and with a front facing camera, a digital single-lens reflex (DSLR) camera with a flip display screen, a mirrorless camera with a flip display screen, or the like.

The lighting portion 104 includes a light 110, an arm portion 112, and a swivel mount 114. The arm portion 112 includes first and second portions 120 and 112, which are connected together via a screw 124. The device holder 106 includes a mount 130 having a channel 132 therein, a top clamp portion 134, a bottom clamp portion 136, and an adjustment portion 138. The portable door video production system 100 also includes a lens 140 with a clamp 142.

Referring now to FIG. 2, the portable door video production system 100 further includes a base 202 and an extension portion 204. The base 202 includes a bracket 210, and an adjustable screw 212. In an embodiment, the bracket 210 and the adjustable screw 212 of the base 202 can be replaced with a spring clamp, a notch driven clamp, or any similar locking/clamping feature without varying from the scope of the disclosure. The extension portion 204 includes arms 220 and 222, and a screw 224. During installation of the portable door video production system 100, the user can place the bracket 210 of the base 202 around an edge of the door 102 at any desired height, such as at a height that is substantially equal to the user's head. In an embodiment, the bracket 210 can be a ‘C’ shaped bracket with three portions and an opening. Thus, when the bracket 210 is slipped over an edge of the door 102, the door 102 can be placed in between two of the portions and the third portion can be placed in physical communication with the edge of the door 102. The user can then securely attach the base 202 to the door 102 by tightening the adjustable screw 212 until the door 102 is securely held between one of the portions of the bracket 210 and the adjustable screw 212. In an embodiment, the base 202 can be securely attached to the door 102 by a user squeezing a clamp of the base 202 to open the clamp enough to slip the clamp over an edge of the door 102, and then releasing the clamp to cause the clamp to securely hold onto the door 102.

Referring back to FIG. 1, the user can connect the lens 140 over a lens of a camera built into the device 108 and can use the display screen of the device 108 to verify that the position of the lens 140 is correct. The lens 140 can then be held in place on the device 108 via the clamp 142. In this embodiment, the camera built into the device 108 can be a front facing camera so that the display screen of the device 108 is facing toward the user. In another embodiment, the device 108 can be a DSLR camera or mirrorless camera with a flip display screen, such that the user can rotate the display screen to face the same direction as the lens of the DSLR or mirrorless camera so that the user can view the display screen while filming. The user can connect the device 108 to the device holder 106. In an embodiment, the user can place the device 108 in physical communication with the mount 130 and with the top clamp portion 134. The user can then slide the bottom clamp portion 136 along the channel 132 until the device 108 is securely held in between the top clamp portion 134 and the bottom clamp portion 136. In an embodiment, adjustment of the bottom clamp portion 136 along the mount 130 via the channel 132 can enable different sized devices to be held within the device holder 106. In an embodiment, the user can mount the device 108 such that a display screen of the device 108 is facing the user to enable the user to see what the image looks like.

The user can then connect the device holder 106 to the base 202 via the extension portion 204. In an embodiment, the adjustment portion 138 of the device holder 106 can connect to the arm 220 of the extension portion 204 in a ball-and-socket configuration. In this embodiment, the adjustment portion 138 can be loosened on the arm 220 to allow the device holder 106 to be rotated and tilted in all directions. Therefore, in response to the loosening of the adjustment portion 138, the user can move the device holder 106 until the image on the display of the device 108 shows a desired view of the user.

The user can also move a location of the device 108 by extending or retracting the extension portion 204. For example, the user can loosen the screw 224 and pull or push on the device holder 106, which in turn can cause the arms 220 and 222 to move accordingly. When the user has the device 108 in a desired position based on the movement of the extension portion 204, the user can tighten the screw 224 and the extension portion can be locked into position.

The lighting portion 104 can be connected to the base 202 via the arm 122 of the arm portion 112. In an embodiment, the arm 122 can mount to the base 202 by any know method that enables the arm to change positions with respect to the base 202, such as a ball-and-socket joint. The screw 124 can then be loosened to allow the arms 120 and 122 to change positions with respect to one another with the screw 124 acting as the pivot point for the movement. The screw 124 can then be tightened to hold the arms 120 and 122 in a desired position. The light 110 can be connected to the arm 120 via the swivel mount 114, which in turn can be utilized to further adjust the position of the light 110. Thus, the position and angle of the light 110 can be adjusted and aligned, via the arm portion 112 and the swivel mount 114 to provide a direction of the light to the user during the filming of a video. In an embodiment, the light 110 can be an adjustable light, such that the user can control, via a control panel on the back of the light 110, the brightness, hue, and other light characteristics until the image on the device 108 has the correct lighting.

The portable door video production system 100 can further includes measuring devices 150 and 152. The measuring devices 150 and 152 can be any type of device capable of measuring a specific distance, such as a measuring tape, a ribbon, a length of cloth, or the like. The measuring device 150 can be connected to the lighting portion 104, such as the swivel mount 114. The measuring device 152 can be connected to the mount 130 of the device holder 106. In an embodiment, the measuring devices 150 and 152 can be connected to the portable door video production system 100 in a non-permanent manner so that if one of the measuring devices is pulled on with a lot of force the measuring device will break away from the portable door video production system 100 without pulling any part or all of the portable video production system over. In another embodiment, the measuring devices 150 and 152 can be securely and permanently attached to the portable door video production system 100.

The user can then determine the proper distance to stand from the device 108 by extended the measuring device 152 from the center of the mount 130 to the user's body. The user is standing the proper distance from device 108 when the measuring device 152 only touches the user's body after being fully extended. The user can measure the distance from the light 110 to the user by extending the measuring device 150 from the light 110 to the user's chest. The light 110 is the proper distance from the user when the measuring device 150 only touches the user's chest after being fully extended.

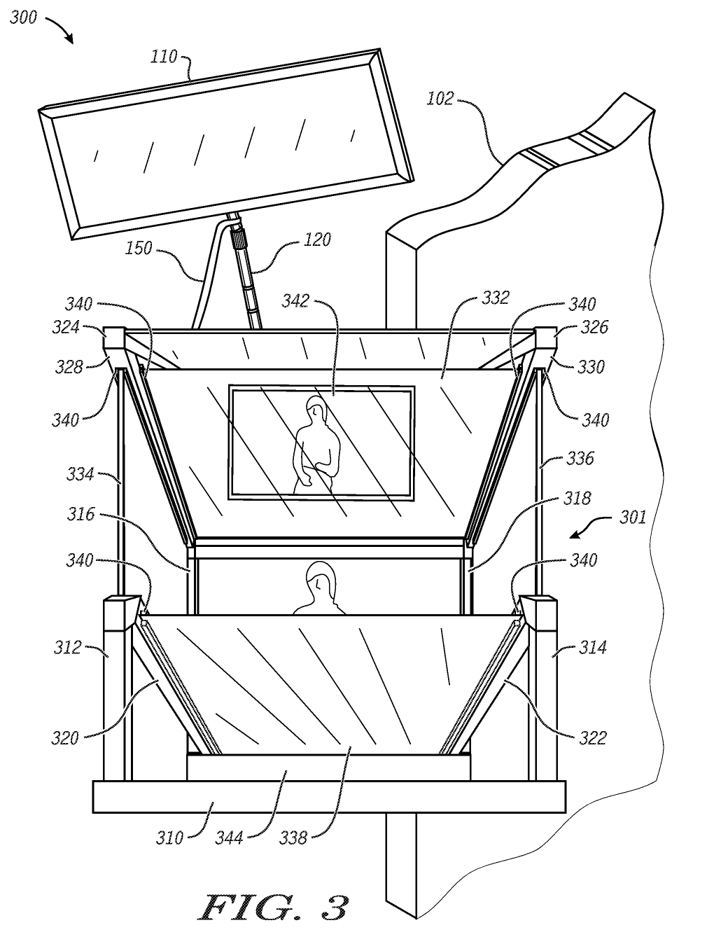

FIG. 3 illustrates a front view of a portable door video production system 300 including a prompter portion 301 connected in front of a device 108 of the portable door video production system 300 in accordance with at least one embodiment of the present disclosure. The prompter portion 301 includes a tray 310, legs 312, 314, 316, and 318, supports 320, 322, 324, 326, 328, and 330, glass 332, 334, and 336, and a mirror 338.

The legs 312, 314, 316, and 318 of the prompter portion 301 are preferably connected together by the supports 320, 322, 324, 326, 328, and 330. For example, one end of the support 320 connects to a bottom portion of the leg 316, and the support extends upward at an angle so that the opposite end of the support connects to a top portion of the leg 312. Similarly, one end of the support 322 connects to a bottom portion of the leg 318, and the support extends upward at an angle so that the opposite end of the support connects to a top portion of the leg 314. The support 324 preferably extends away from the top portion of the leg 316 toward the front of the prompter portion 301. In an embodiment, the support 324 can extend from the leg 316 at a ninety degree angle. The support 340 extends from a location of the leg 316 that is between the bottom and the top of the leg, extends upward and toward the front of the prompter portion 301, and connects with an opposite end of the support 324 than leg 316. The support 326 preferably extends away from the top portion of the leg 318 toward the front of the prompter portion 301. In an embodiment, the support 326 can extend from the leg 318 at a ninety degree angle. The support 330 extends from a location of the leg 318 that is between the bottom and the top of the leg, extends upward and toward the front of the prompter portion 301, and connects with an opposite end of the support 326 than leg 318.

The mirror 338 of the prompter portion 301 can be positioned between the supports 320 and 332, and is preferably angled to provide a reflection of the display of a laptop 344 onto the piece of glass 332, which can be positioned between the supports 328 and 330. The reflection of the display from the mirror 338 can be reflected off the piece of glass 332 and provided as reflected image 342 to a user as shown in FIG. 3. The piece of glass 332 can be a piece of teleprompter glass or the like that can provide the reflected image 342 to the user and at the same time can enable a video of a user to be recorded through the piece of glass without the reflected image appearing in the video. The reflected image 342 can be displayed in an upright position with the same orientation as the display of the laptop 344.

The piece of glass 334 can be connected between the supports 320 and 328 and can be any type of opaque material. Similarly, the piece of glass 336 can be connected between the supports 322 and 330 and can be any type of opaque material. In an embodiment, the supports 320, 322, 328, and 330 can each include channels 340 (shown in FIG. 3) that the mirror 338 and pieces of glass 332, 334, and 336 can slide between so that the mirror and pieces of glass can be held in a proper location. For example, channels 340 on inner portion of supports 320 and 322 can hold the mirror 338 in place between these supports. The channels 340 on inner portions of supports 328 and 330 can hold the glass 332 in place to provide the reflected image 342 to the user. A channel 340 on the bottom portion of support 328 and a channel 340 on a top portion of support 320 can hold the glass 334 in place. Similarly, the channel 340 on the bottom portion of support 330 and the channel 340 on the top portion of the support 322 can hold the glass 336 in place.

The channels 340 can provide easy access to the mirror 338 and pieces of glass 332, 334, and 336 so that the user can easily remove the mirror and pieces of glass from the prompter portion 301. The user can remove the mirror 342 and pieces of glass 332, 334, and 336 to clean the mirror and pieces of glass, to move the portable door video production system 100, or the like. The laptop 344 can be placed in a specific location on the tray 310 to enable the display of the laptop 334 to be reflected by mirror 338 to create the reflected image 342 on the glass 332.

The user can wirelessly connect the device 107 with the laptop 344 via any short range wireless protocol, such as Bluetooth or the like. The laptop 344 can then display the image of a screen of the device 107, which can then be reflect off the mirror 338 and glass 332 as the reflected image 342. The user can also utilize the image 342 to read and/or otherwise view information from the device 107 while looking directly at the lens 140.

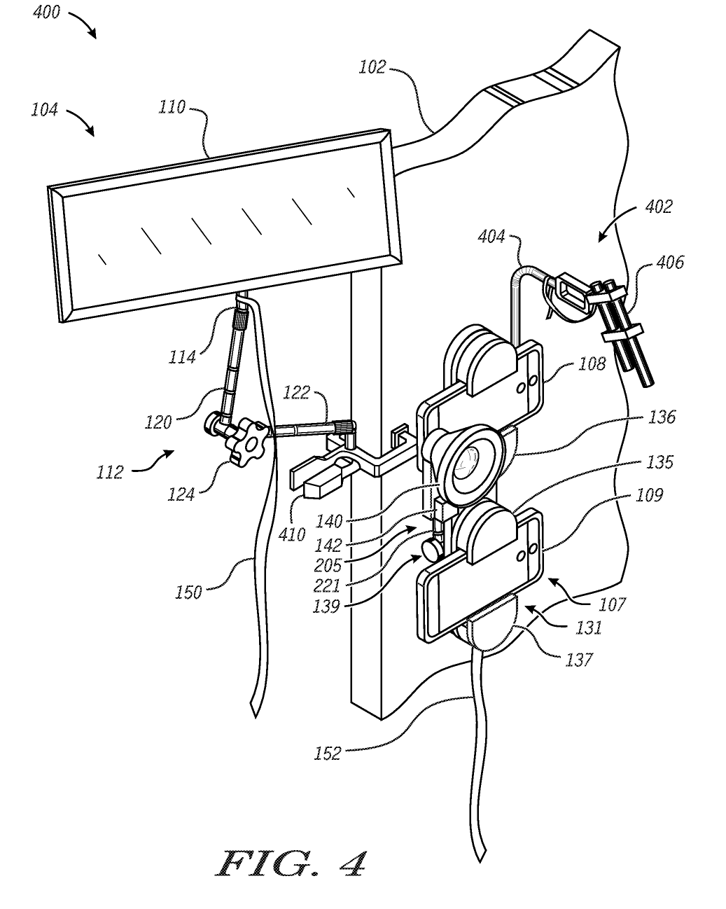

FIG. 4 illustrates a front view of the portable door video production system 400 including a microphone portion 402 connected to the device 108 in accordance with at least one embodiment of the present disclosure. The microphone portion 402 includes an arm 404, and a microphone 406. The arm 404 of the microphone portion 402 extends from the base 202 above the device 108 to provide a desired height for the microphone 406 in relation to the portable door video production system 100. The microphone 406 can be positioned to provide a desired angle and distance from the user via the arm 404. The arm 404 can be a flexible arm that can be moved different directions to make the microphone 406 point substantially at the user's mouth.

The portable video production system 400 may also include an additional device holder 107. The device holder 107 includes a mount 131 having a channel therein, a top clamp portion 135, a bottom clamp portion 137, and an adjustment portion 139. The device holder 107 can securely mount a device 109 within the device holder 107 in substantially the same way as the device 108 is mounted within device holder 106. The user can connect the device holder 107 to the base 202. In an embodiment, the adjustment portion 139 of the device holder 107 can connect to an arm 221 of an extension portion 205 in a ball-and-socket configuration. In this embodiment, the adjustment portion 139 can be loosened on the arm 221 to allow the device holder 107 to be rotated and tilted in all directions. Therefore, in response to the loosening of the adjustment portion 139, the user can move the device holder 107 until the image on the display of the device 109 shows a desired view of the user. The adjustment portion 139 may be easily attached and removed from the arm 221 so that the device holder 107 can be connected to the portable door video production system 400 only when the device 107 will be used during the filming. During filming, the device 107 can be utilized to provide lines for the user to read while being recorded by the device 108. In an embodiment, the device holder 107 can be connected anywhere on the portable video production system 400, such as below the device holder 106 as shown in FIG. 4, to the side of the device holder 106, or the like.

The user can begin recording a video production after the user has finished setting up the device 108 and the light 110. In an embodiment, the user may also set up the prompter portion 301 and the microphone 406. Also, the microphone 406 can be plugged into an audio input of the device 108 to provide high quality audio to the device 108. After the video production has been recorded the user can send the video and audio to a remote server to be accessed and edited into a final video production.

The images on the screen of the device 107 can also be transmitted along with the recorded video and audio to the remote server for use in editing together the final video production. In particular, during the editing process the images on the screen of the device 107 can be placed within the video from the device 108. For example, during the editing process the images from the screen of device 107 can be place above one of the shoulders of the user.

The device 108 can include a wireless communication capability, such that the video and audio can be sent to the remote server without the user having to connect the device 108 to a local Internet connection point. The wireless capability of the camera 108 can provide different options for transferring the video and audio to the remote server, such as file transfer protocol, and the like. Thus, the user can utilize the portable door video production system 100 to create a high quality video production at any door 102 without having a film crew coming out to the location.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily limit any of the various claimed inventions. To the contrary, the description of the exemplary embodiments are intended to cover alternative, modifications, and equivalents as may be included within the spirit and scope of the invention as defined by the claims. Moreover, some statements may apply to some inventive features but not to others.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A portable door video production system comprising:
a base configured to securely mount on an edge of a door;
a device holder configured to be coupled with the base, the device holder to swivel and move in relation to the base mounted on the door, and to hold a device a desired position to provide a proper angle to film a user; and
a lighting portion configured to be coupled with the device holder, the lighting portion includes a light, the lighting portion configured to hold the light in a desired lighting position.

2. The portable door video production system of claim 1 wherein the base comprises:
a bracket to be placed in physical communication with the edge of the door; and
an adjustable screw coupled to the bracket, and in response to the adjustable screw being tighten the bracket and the adjustable screw to bind on the door to securely mount the base on the edge of the door.

3. The portable door video production system of claim 1 wherein the lighting portion comprises:
an arm portion to extend and compress to change a location of the light with respect to the device holder; and
a swivel mount coupled in between the light and the arm portion, the swivel mount to enable the light to tilt different directions to change an angle of the light with respect to the device holder.

4. The portable door video production system of claim 1 further comprising:
a lens to be placed over a camera of the device; and
a clamp to hold the lens in place on the device.

5. The portable door video production system of claim 1 further comprising:
an extension portion configured to be connected in between the base and the device holder, the extension portion to extend and compress to change a distance of the device holder from the base.

6. The portable door video production system of claim 1 further comprising:
a first measuring component connected to the device holder, the first measuring component to extend from the device holder and being of a first specific length to indicate a distance for the user to stand from the device holder.

7. The portable door video production system of claim 6 further comprising:
a second measuring component connected to the lighting portion, the second measuring component to extend from the lighting portion and being of a second specific length to indicate a distance for the user to stand from the lighting portion.

8. The portable door video production system of claim 1 wherein the desired lighting position is based on lighting of an image displayed on the device.

9. A portable door video production system comprising:
a base configured to securely mount on an edge of a door;
a device holder configured to be coupled with the base, the device holder to swivel and move in relation to the base mounted on the door, the device holder comprising:
a mount including a channel;
a top clamp portion connected to a first end of the mount; and
a bottom clamp portion to adjust along the mount via the channel, the top clamp portion and the bottom clamp portion to hold a device a desired position to provide a proper angle to film a user; and
a lighting portion configured to be coupled with the device holder, the lighting portion includes a light, the lighting portion configured to hold the light in a desired lighting position.

10. The portable door video production system of claim 9 wherein the base comprises:
a bracket to be placed in physical communication with the edge of the door; and
an adjustable screw coupled to the bracket, and in response to the adjustable screw being tighten the bracket and the adjustable screw to bind on the door to securely mount the base on the edge of the door.

11. The portable door video production system of claim 9 wherein the lighting portion comprises:
an arm portion to extend and compress to change a location of the light with respect to the device holder; and
a swivel mount coupled in between the light and the arm portion, the swivel mount to enable the light to tilt different directions to change an angle of the light with respect to the device holder.

12. The portable door video production system of claim 9 further comprising:
a lens to be placed over a camera of the device; and
a clamp to hold the lens in place on the device.

13. The portable door video production system of claim 9 further comprising:
an extension portion configured to be connected in between the base and the device holder, the extension portion to extend and compress to change a distance of the device holder from the base.

14. The portable door video production system of claim 9 further comprising:
a first measuring component connected to the device holder, the first measuring component to extend from the device holder and being of a first specific length to indicate a distance for the user to stand from the device holder.

15. The portable door video production system of claim 14 further comprising:
a second measuring component connected to the lighting portion, the second measuring component to extend from the lighting portion and being of a second specific length to indicate a distance for the user to stand from the lighting portion.

16. The portable door video production system of claim 9 wherein the desired lighting position is based on lighting of an image displayed on the device.

17. The portable door video production system of claim 9 the device holder to hold devices of different sizes based on a distance between the top clamp portion and the bottom clamp portion.

18. A portable door video production system comprising:
a base including:
a clamp to bind on the door to securely mount the base on the edge of the door;
a device holder configured to be coupled with the base, the device holder to swivel and move in relation to the base mounted on the door, and to hold a device a desired position to provide a proper angle to film a user; and
a lighting portion configured to be coupled with the device holder, the lighting portion includes:
a light;
an arm portion to extend and compress to change a location of the light with respect to the device holder; and
a swivel mount coupled in between the light and the arm portion, the swivel mount to enable the light to tilt different directions to change an angle of the light with respect to the device holder, the arm portion and the swivel mount to hold the light in a desired lighting position.

19. The portable door video production system of claim 1 further comprising:
an extension portion configured to be connected in between the base and the device holder, the extension portion to extend and compress to change a distance of the device holder from the base.

20. The portable door video production system of claim 1 wherein the desired lighting position is based on lighting of an image displayed on the device.
